(19) United States
(12) Patent Application Publication
(10) Pub. No.: US 2021/0014073 A1
(43) Pub. Date: Jan. 14, 2021

(54) DECENTRANLISED COMMUNICATION SYSTEM AND METHOD

(71) Applicant: COMMUNICATION SECURITY GROUP INC., George Town (KY)

(72) Inventors: Mark CURRIE, George Town (KY); Harvey BOULTER, George Town (KY)

(21) Appl. No.: 17/040,228

(22) PCT Filed: Mar. 22, 2019
(86) PCT No.: PCT/GB2019/050824

§ 371 Date: Sep. 22, 2020

(30) Foreign Application Priority Data
Mar. 22, 2018 (GB) 1804614.4
May 15, 2018 (GB) 1807854.3

(51) Int. Cl. H04L 9/32; H04L 9/08; H04L 9/06

(52) U.S. Cl. CPC H04L 9/3255; H04L 9/0841; H04L 9/3236; H04L 2209/56; H04L 9/0643; H04L 2209/38; H04L 9/088

(57) ABSTRACT

Decentralised Communication System and Method A decentralised communication system (10) is disclosed. The decentralised communication system includes a proxy system (20) having a single address associated with a plurality recipient systems (40a-40c). The proxy system 20 is configured to provide a received message addressed to the address to each of the plurality of associated recipient systems (40a-40c). A public key data repository (30) stores a static public key (31a-31c) and a plurality of ephemeral public keys (32a1-32an . . . 32c1-32cn) for each of the plurality of recipient systems (40a-40c). A message (50) to a selected one of the recipient systems 40a-40c includes an encrypted marker (51) and an encrypted message body (52). The message body (51) is encrypted using the recipient system's static public key, a selected ephemeral public key of the recipient system, the private key corresponding to the sender's static public key and the private key for a selected one of the sender's ephemeral public keys. The marker (51) is encrypted using the recipient's static public key and the encrypted content includes the sender's static key and the selected ephemeral public keys used to encrypt the message body such that the marker is only decryptable by the selected recipient system and the encrypted marker reveals no information about the sender or recipient system.

### FIELD OF THE INVENTION

The present invention relates to a decentralised communication system and method that are particularly applicable to anonymous communications where neither the parties to the communication nor the content of the communication is evident from the communicated messages.

### BACKGROUND TO THE INVENTION

There are many instances where parties may wish to communicate confidentially. It will be appreciated that this is not straightforward, particularly where public data communications networks are used to route communications.

Many users now understand that their communications may not be safe from eavesdroppers. Users may use encryption of messages or even encrypted links such as virtual private networks to increase privacy and confidentiality.

It is not just communications in transit that are at risk of eavesdroppers—there is an increasing industry that monitors corporate or celebrity activity to second guess commercial product launches, share pricing issues or other activities that can have a value attributed to them. For example: a spike in communications between two corporations might imply a takeover/merger that could trigger share trading; the filing of a trademark by a computer games designer likely identifies the name of an upcoming game release etc that may undermine planned promotions, cause corresponding web domains to be bought by cyber-squatters etc.

Another instance where privacy/anonymity is desirable is in payments. While bitcoin is regarded by many as anonymous electronic cash, it, like the underlying blockchain it uses, is traceable. Transactions are public and unambiguously link a unique origin and recipient.

### STATEMENT OF INVENTION

According to an aspect of the present invention, there is provided a decentralised communication system comprising:

a proxy system having a single address associated with a plurality recipient systems, the proxy system being configured to provide a received message addressed to the address to each of the plurality of associated recipient systems;

a public key data repository storing a static public key and a plurality of ephemeral public keys for each of the plurality of recipient systems;

wherein a message to a selected one of the recipient systems includes an encrypted marker and an encrypted message body,

the message body being encrypted by a sender using the recipient system's static public key, an ephemeral public key of the recipient system and private keys corresponding to the sender's static public key and a selected one of the sender's ephemeral public keys;

the marker being encrypted using the recipient's static public key and including the sender's static key, and the ephemeral public keys used to encrypt the message body,

whereby the marker is only decryptable by the selected recipient system and the encrypted marker reveals no information about the sender or recipient system.

The public key data repository preferably comprises a decentralised ledger system. The decentralised ledger system preferably comprises a blockchain.

The proxy system is preferably treated as one of the recipient systems (it may be dual-purpose and acting as a true recipient system operated by a user or else it may have the sole role as a proxy system but communicate using the encrypted messaging system). It preferably has a static public key and plurality of ephemeral public keys in the public key data repository, a message to the proxy system being sent to the single address and encrypted in the same way as a message to others of the recipient systems whereby an observer cannot distinguish proxy request messages from messages intended for other recipients on the network.

The proxy system may be configured to receive a message from one of the recipient systems instructing a payment to a payee, the proxy system being responsive to create a smart contract on a decentralised ledger designating the proxy system as the payment identity and a smart contract condition that can only be met by the instructing recipient system, the proxy system being arranged to send the payee system a message referencing the smart contract.

The decentralised communication system may further comprise a recipient system client, the recipient system client being executable on a recipient system to register an address for the recipient system with the proxy system for delivery of the recipient's copy of messages addressed to the single address.

The decentralised communication system may further comprise a recipient system client, the recipient system client being executable on a recipient system to retrieve messages from the proxy system addressed to the single address.

The recipient system client is preferably executable on the recipient system to communicate the recipient system's static public key and ephemeral public keys to the proxy system for storing in the public key data repository.

The recipient system client may be executable on the recipient system to download and store locally at least a subset of the public keys from the public key data repository, the recipient system client including a user interface configured to accept user inputs for locally selecting a recipient system to message, the recipient system client being arranged to select a corresponding recipient system ephemeral public key for the message from the local store.

The recipient system client is preferably configured to attempt to decrypt the marker of each message received from the proxy system using a private key corresponding to its public static key, wherein upon successful decryption of the marker, the recipient system client being configured to recover the sender's static key, and the ephemeral public keys used to encrypt the message body for subsequently decrypting the message body. The recipient system client may, for example, notify the user of a message, immediately decrypt the message body or perform it on demand.

According to another aspect of the present invention, there is provided a decentralised communication method comprising:

storing, in a public key data repository, a static public key, a plurality of ephemeral public keys and a link to a proxy system for each of a plurality of recipient systems;

generating, by a sending system, an encrypted message, the encrypted message having an encrypted marker and an encrypted body, the message body being encrypted by the sender system using the recipient system's static public key, an ephemeral public key of the recipient system and private keys corresponding to the sender's static public key and a selected one of the sender's ephemeral public keys;

the marker being encrypted by the sender system using the recipient's static public key and including the sender's static key, and the ephemeral public keys used to encrypt the message body;

sending the encrypted message to an address at the proxy system that is common to the plurality of recipient systems;

providing, by the proxy system to each of the plurality of recipient systems, the received message, whereby the marker is only decryptable by the selected recipient system and the encrypted marker reveals no information about the sender or recipient system.

The step of generating may include the step of retrieving the recipient system's static public key and one of the recipient system's ephemeral public keys from the public key data repository.

The method may include a step of downloading and locally caching at least a subset of the public keys from the public key data repository, the step of generating using the locally cached public keys. A selectable number of recipient system public keys may be downloaded from the proxy, allowing the requestor to anonymously select a specific recipient system's public keys.

The method may further comprise storing a static public key and plurality of ephemeral public keys in the public key data repository for the proxy system and encrypting and sending a message to the proxy system in the same way as a message to others of the recipient systems whereby an observer cannot distinguish proxy request messages from messages intended for other recipients on the network.

The method may further comprise sending, by the sending system, a message having a marker encrypted for decryption by the proxy system, the encrypted message body instructing a payment to a payee;

creating, by the proxy system a smart contract on a decentralised ledger designating the proxy system as the payment identity and a smart contract condition that can only be met by the sending system;

sending, by the proxy system a payment message having a marker encrypted for decryption by the payee, the encrypted payment message body referencing the smart contract.

The method may further comprise transferring ownership of an account protected by a public/private key pair to recipient system by sending the private key in the encrypted body of a message having a marker encrypted for decryption by the recipient system. The account may be the messaging system account, an account holding a payment such as crypto coins or some other account.

Embodiments of the present invention seek to provide a decentralised communication system and method in which messages can be communicated between parties in a secure manner and also communicated in a way in which the sender and recipient do not need to be identified.

With new advances in scalable third generation blockchain technologies, few provisions are made for user privacy and/or anonymity. Embodiments of the present invention seek to provide methods and systems that enable privacy and anonymity to be added onto existing blockchains. In one embodiment, a legitimate blockchain user ID is used as a proxy for a group of private/anonymous users. The proxy copies all received messages/transactions to all its group users, such that the source and destination user identities cannot be determined by observing the online data or data traffic patterns. Group user messages are encrypted in such a way that only the intended recipients can decrypt the messages and the source and destination identities are hidden from all other users. Sender and receiver activities cannot be correlated since all messages are indistinguishable from normal proxy requests (which are frequent). Multiple proxies can exist, and their group users can communicate with users from other proxy groups. This allows the scheme to be scalable, while restricting the number of messages that need to be processed by each group user. Payments can be made through smart contracts which are bound in the blockchain. The blockchain contracts allow payments to be made to other blockchain user ID's, or contracts, only by consent of both the proxy ID and the private/anonymous funds owner, wherein the identity of the funds owner cannot be established online. The anonymous messaging system according to embodiments of the present invention can be used to provide the funds owner with the necessary means to control the funds. By combining the anonymous messaging system with a payment system, it is possible to avoid payment tracking through: the transfer of ownership of an account by sending the account private key via anonymous message; establishing multiple accounts, and making multiple transfers to multiple accounts (shotgun approach).

In embodiments of the present invention, a messaging system provides anonymity on-the-wire and includes Off-The-Record (OTR) communications with Forward Secrecy. A public key blockchain or other distributed ledger or database is maintained for participants containing all the user public key records from all proxy groups. These records include static and ephemeral public keys and may optionally include public key certificates and revoked public keys. Users (recipient systems) preferably maintain synchronized local copies of the keys including all messages received by the group proxy identity. Normal messages (not payments) can exist in a blockchain, or outside a blockchain. Messages that exist outside the blockchain are still distributed by the proxy to all proxy group members to maintain anonymity. Since the messages do not reveal source and destination information, and since these are only accessed off-the-wire, it is not possible to determine who received what from whom. Furthermore, short-term (ephemeral) keys used in the encryption protocol are regularly updated in the key blockchain, thus providing Forward Secrecy on all previous messages. Messages sent from a proxy group member to the proxy itself are also preferably distributed to the group and use the same encryption mechanism so that it is not feasible to determine whether they are proxy instructions or just messages to other group members. Since all links are secured using normal HTTPS encryption, and users can specify how many messages they wish to receive on any given request, it is not necessary for the proxy to distribute its own messages.

### BRIEF DESCRIPTION OF THE DRAWINGS

Embodiments of the present invention will now be described by way of example only with reference to the accompanying drawings, in which:

FIG. 1 is a schematic diagram of a decentralised communication system according to an embodiment;

FIG. 2 is a diagram illustrating a data structure for a public key data repository according to an embodiment;

FIG. 3 is a diagram illustrating steps in encrypting and sending a communication in a method according to an embodiment;

FIG. 4 is a diagram illustrating steps in receiving and decrypting a communication in a method according to an embodiment; and,

FIG. 5 is an illustration of tokens using the decentralised communication system for payments.

### DETAILED DESCRIPTION

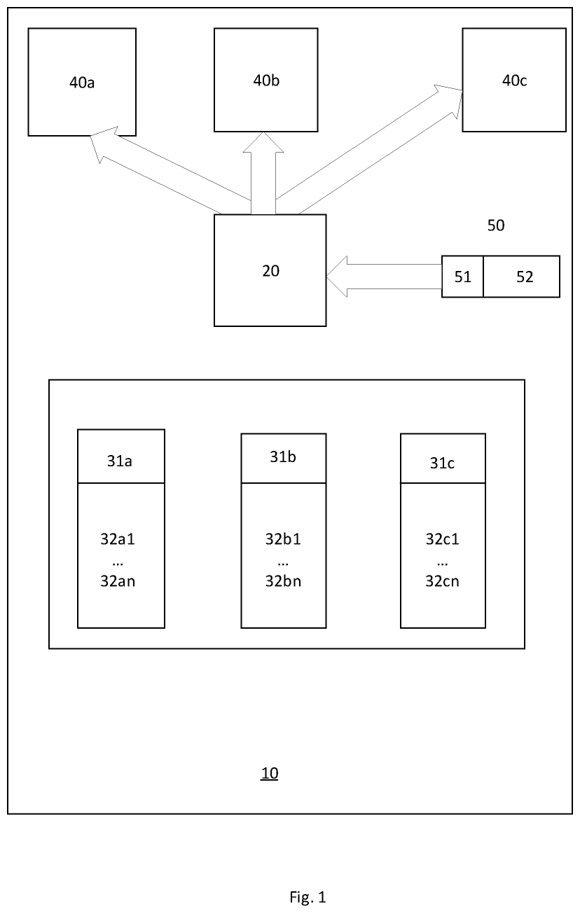

FIG. 1 is a schematic diagram of a decentralised communication system according to an embodiment.

The decentralised communication system 10 includes a proxy system 20 and a public key data repository 30.

The proxy system 20 has a single address, A, associated with a plurality recipient systems 40a-40c. The proxy system is configured to provide a received message addressed to the address A to each of the plurality of associated recipient systems 40a-40c (the plurality of associated recipient systems are referred to herein as the group).

The proxy system 20 may operate as a pull delivery mechanism in which recipient systems retrieve messages from the proxy (for example on a scheduled basis, on demand etc). Alternatively, the proxy system 20 may maintain a database of IP addresses or similar and push copies of messages (or notification of received messages) to the associated recipient systems.

The messages are encrypted. Preferably, there is a mechanism built into the encryption of the message that enables each recipient system 40a-40e to test to see if it is the message's intended recipient. Only upon successful testing of the message does the recipient system need to decrypt the message body.

The public key data repository 30 stores a static public key 31a-31c and a plurality of ephemeral public keys 32a1-32an . . . 32c1-32cn for each of the plurality of recipient systems 40a-40c.

A message 50 to a selected one of the recipient systems 40a-40c includes an encrypted marker 51 and an encrypted message body 52. The message body 51 is encrypted using the recipient system's static public key, a selected ephemeral public key of the recipient system, the private key corresponding to the sender's static public key and the private key for a selected one of the sender's ephemeral public keys.

The marker 51 is encrypted using the recipient's static public key and the encrypted content includes the sender's static key and the selected ephemeral public keys used to encrypt the message body.

In this manner, the marker 51 is only decryptable by the selected recipient system using their private key corresponding to their static key. Once the marker 51 is successfully decrypted, the recipient can recover the sender's static public key and the selected ephemeral public keys of the sender and recipient. These can then be used to decrypt the encrypted message body as described below.

In this example only three recipient systems are shown as the group for simplicity of illustration, although in practice the number of recipient systems may be substantially higher. It will be appreciated that the proxy system 20 may maintain multiple groups and the decentralised communication system 10 may also operate multiple proxy systems 20. Recipient systems can also be members of multiple groups. The maximum membership of groups may be controlled. For example, registrations may be made to the proxy system 20 by recipient systems (and the proxy system 20 then joins the recipient system to a group with capacity) or it may be via some centralised system that handles group membership. Upon a group meeting a predetermined capacity, a new group may be created for the proxy or an existing group may be split. While group membership will depend on traffic type and size, a single group could potentially have 1000-10,000 member recipient systems.

The public key data repository preferably comprises a decentralised ledger system such as a blockchain or the like. The decentralised ledger may be a public blockchain, a private blockchain or a operate under some form of consortium model. As will be described in more detail below, making the public keys available on a public blockchain or similar does not impact the security and anonymity of the messaging infrastructure.

As indicated above, it is preferred that the public key data repository uses a blockchain or similar distributed ledger to store the recipient systems' public keys.

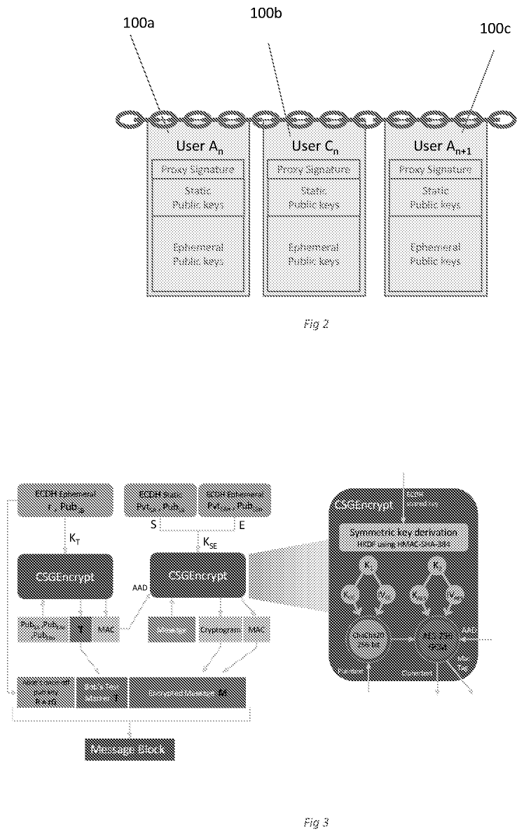

For each recipient 40a-40c system the public key data repository preferably includes a corresponding record 100a-100c as illustrated in FIG. 2. Each record 100a-100c includes the recipient system's static public key 31a-31c and also a string of ephemeral public keys 32a1-32an . . . 32c1-32cn.

The key blockchain, including all group user keys, is maintained by all group recipient systems and periodically synchronised. In this way it is possible for a sender to choose a destination public key without revealing the destination on the wire. Periodically, each recipient system can update their ephemeral keys and disable old ones. When a recipient system registers with a proxy system 20, the proxy system 20 writes the recipient system's public keys into the key blockchain, and digitally signs them. Group recipient systems can also update their keys by requesting the proxy to add a new key block in the chain. The latest, or highest numbered key block for a particular user, is the current key record for that user.

Preferably, the proxy system 20, as well as acting as the proxy system to provide messages to the address A to all associated recipients, is also registered with itself as one of the recipient systems for address A and has a static public key and plurality of ephemeral public keys in the public key data repository 30. Recipient systems 40a-40c can communicate with the proxy system 20 using encrypted messages. Recipient systems 40a-40c can use this approach to update their ephemeral public keys and also take advantage of other services offered by the proxy system 20 such as anonymised financial transactions which are described in more detail below.

### Common Terms

In the following discussion, various common terms are used:

Alice and Bob are used to designate sender and receiver systems, respectively.

The elliptic curve multiplicative group generator parameter: G

Unique messaging identifiers for Alice and Bob: ID_{A} and ID_{B}

Alice's static and ephemeral EC key pairs respectively: Pvt_{SA}, Pub_{SA} and Pvt_{EA}, Pub_{EA}

Bob's static and ephemeral EC key pairs respectively: Pvt_{SB}, Pub_{SB} and Pvt_{EB}, Pub_{EB}

The CSGEncrypt and CSGDecrypt functions shown in FIG. 2 and FIG. 3 respectively describe symmetric key encryption and decryption using two standard algorithms (RFC 7539-ChaCha20) and AES in GCM mode (NIST SP800-38D). Both algorithms use a 256-bit key and 128-bit Initial Vector (IV). The keys K1 and K2 are 384-bit keys derived using the standard Hash-based Key Derivation Function (HKDF) (FIPS SP 800-56C) with standard hash function SHA-384 (NIST PUB 180-4). K1 and K2 are both split into a 256-bit key and 128-bit IV as shown in FIG. 2 and FIG. 3. The AES cipher, configured in GCM mode, produces a 128-bit Message Authentication Code (MAC) and accepts Additional Authentication Data (AAD) as an external input to the MAC function. It will be appreciated that the cryptographic algorithms and key lengths used are by way of example only and others could be used.

FIG. 3 is a diagram illustrating steps in encrypting and sending a communication in a method according to an embodiment.

In order to encrypt a message in the format shown in FIG. 1, the marker is created and its content encrypted. The content of the marker is used to encrypt the message body. The encrypted marker and the encrypted message body are then combined to form the encrypted message.

Marker Creation

Alice wishes to communicate with Bob. Alice generates the marker. The marker anonymises Alice's identity and can only be decrypted by Bob.

Bob (and all other recipient systems in Bob's group) test markers of all incoming messages to determine if the message is for him or not. Bob's successful verification of the resultant marker Message Authentication Code (MAC_{T}) confirms that the associated message is indeed meant for Bob.

Alice first obtains Bob's static public key Pub_{SB} and current ephemeral public key Pub_{EBn} from the public key data repository 30 (or a local synchronised cache). These may be obtained by using Bob's unique network identifier ID to extract his latest keys from the public key data repository 30

Alice generates a random r and associated one-time EC public key R=r.G

Alice computes a one-time shared ECDH key between Alice and Bob K_{T}=r.Pub_{SB}. This is used as the shared key in the CDGEncrypt function.

Using the key K_{T}, the CSGEncrypt function is applied over plaintext data consisting of Pub_{SA}, Pub_{EAn} and Pub_{EBn}

The resulting ciphertext T is used as the marker in the message. The marker is used by recipients to determine if the corresponding message is for them, and contains the necessary public key material to be used in decrypting the associated message M.

The resultant MAC output from CSGEncrypt is used as an input into the message encryption phase, thus cryptographically binding the marker with the message M itself.

Body Encryption

Using Bob's static and ephemeral public keys Pub_{SB} and Pub_{EBn}, together with Alice's private keys Pvt_{SA} and Pvt_{EAn}, Alice generates ECDH static (S) and ephemeral (E) key shares with Bob.

The message encryption key K_{SE} is constructed by concatenating S and E The plaintext message is submitted, together with the MAC output of the Marker encryption process, to the CSGEncrypt function, and is encrypted using the key K_{SE}

The output message block consists of Alice's one-time public key R, Bob's marker T and the encrypted message body.

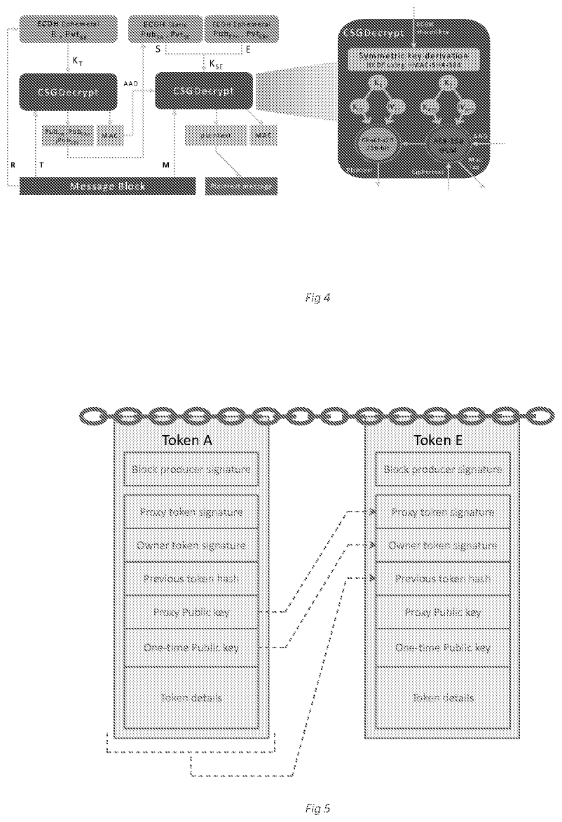

FIG. 4 is a diagram illustrating steps in receiving and decrypting a communication in a method according to an embodiment.

Marker Decryption

Bob tests the markers of all new incoming messages to see if any are for him.

Bob extracts R from the incoming message block and, using his private static key Pvt_{SB}, generates the shared ECDH key K_{T} and performs a trial decryption on the marker using CSGDecrypt. If the resulting MAC verifies successfully, he then knows that the message is intended for him. Only Bob can know this as he must use his static private key Pvt_{SB}. Only Bob knows who sent the message as the correctly decrypted test marker will contain Alice's public keys. In addition to Alice's static public key Pub_{SA}, Bob also recovers Alice's ephemeral public key Pub_{EAn} and Bob's ephemeral key Pub_{EBn} used by Alice in the encryption of the message M.

Body Decryption

Bob then generates K_{SE} using Alice's public keys recovered from the test marker, his private static key Pvt_{SB} and his private ephemeral key (Pvt_{EBn}) associated with the public key sent by Alice (Pub_{EBn}). Using the function CSGDecrypt, Bob recovers the message encrypted by Alice (see FIG. 3). He first checks that the MAC is the same as the MAC delivered with the encrypted message M. If they are the same, then the resultant plaintext output of CSGDecrypt is valid and can be read by Bob.

FIG. 5 is a diagram illustrating a data structure to support anonymised payments using the system of FIG. 1.

In one embodiment, the proxy system 20 may be configured to receive a message from one of the recipient systems 40a-40c instructing a payment to a payee. In order to make a payment, the proxy system 20 creates a smart contract on a decentralised ledger (which may be the blockchain used for the public key data repository 30) designating the proxy system 20 as the payment identity and a smart contract condition that can only be met by the instructing recipient system. The proxy system sends the payee system a message referencing the smart contract.

Payments are made using contracts/tokens. Since blockchain expects individual, identifiable endpoints for payments, the proxy system 20 is used as the payment identity representing the group of private/anonymous transacting users. Payments are managed in a contract signed by the proxy identity and its registered group user (Multisig). The proxy identity is seen, in the host blockchain, as the endpoint for payments, but the smart contract is configured to require conditions to be met before the funds can be transferred. Preferably, the conditions can only be met by the actual group recipient system(s) involved in the payments.

Optionally, the scheme can be set up in a way that allows the proxy system 20 to act as a second signatory for a transaction. Group recipient systems direct the proxy to make payments on their behalf. The contract binds the payments to the individual group recipient system such that the proxy cannot spend the funds on its own. When transfers are made, they can be made to a second contract with conditions set by the initial contract owner such that the second contract can only be fulfilled with those conditions and the conditions are send to the target recipient via the anonymous messaging system described herein.

A Multisig transaction may rely on more than one proxy signature and more than one anonymous user signature e.g. different proxies can be party to the contract. Signatures can be designated different weightings as well as logical AND/OR application. For example, a user at a recipient system can construct a smart contract which requires several signatories, whereby any one (logical OR), or more than one (logical AND), or any logical combination of signatures are required to satisfy the smart contract. In this way an anonymous user is not tied to a specific proxy system 20 to fulfil a contract (decentralised transactions) and may conduct business though any of the contract proxy signatories in the contract. In an alternative method, the proxies could use group or threshold signatures, whereby several proxies are able to create a signature based on a single public key (such as a group signature, see [1] Bellare M., Micciancio D., Warinschi B., “Foundations of Group Signatures: Formal Definitions, Simplified Requirements, and a Construction Based on General Assumptions”, Advances in Cryptology—Eurocrypt 2003 Proceedings, LNCS Vol. 2656, E. Biham ed, Springer-Verlag, 2003, the entire content of which is herein incorporated by reference) and any subset of proxies, up to a certain threshold, can produce the group signature (threshold signature are discussed in Gennaro R. (1), Goldfeder S. (2), Narayanan A. (2), “Threshold-optimal DSA/ECDSA signatures and an application to Bitcoin wallet security”, 2016, (1) City College, City University of New York, (2) Princeton University, the entire content of which is herein incorporated by reference). In this way it would not be necessary to add multiple signatories in a transaction since more than one proxy can be used to satisfy the signature requirement.

Preferably, a dual-signature token 200 is created, where the first signature is always a proxy's signature, and the second is a one-time signature created by an anonymous proxy group recipient system. Embedded in the token is a proxy public key for a future token's first signature verification, and a one-time public key for a future token's second signature verification. Also embedded in the token is a hash of a previous token containing the public keys for verifying the signatures of this token. The private key associated with the embedded one-time public key can be transferred to any future anonymous user via the secure messaging system described above. Note that the intended beneficiary can be the same as the current token owner, for example, to refresh the token in the case where a blockchain may need to be truncated by removing old blocks.

The token details as shown in FIG. 5 may optionally contain an encrypted message that only the future beneficiary can decrypt in the manner described above.

Payments

When a user of a recipient system wishes to make an anonymous payment, the user causes the recipient system to generate one-time ECDH keys and send an anonymous message to the proxy system 20 instructing it to create a new token containing the one-time public key and destination proxy public key. The recipient system then sends the target beneficiary an anonymous message containing the one-time private key required for future token signing.

Instead of an actual private key, a public P, can be sent instead created, for example using a method such as that set out in CryptoNote (Whitepapery 2.0, Nicolas van Saberhagen, Oct. 17, 2013, the entire content of which is herein incorporated by reference), whereby the private key can only be derived by the intended future beneficiary. An example of such an arrangement is as follows:

Alice generates one-time random ECDH private key r and associated public key R=rG, where G is the EC group generator. Alice calculates P=Hash(rA)G+B where A and B are two long-term public keys belonging to the future beneficiary (Bob). Alice sends P, using our the above described secure messaging method, to Bob.

Bob verifies that the transaction is for him by computing P′=Hash(aR)G+B and verifying that P=P′ since aR=rA (ECDH). Bob can now use his private keys a and b to derive the one-time private key associated with P by computing p=Hash(aR)+b. Since P=pG, and B=bG the G's cancelled out.

Cash

The above token scheme can also be applied in Bitcoin transactions since Bitcoin payments allow for more than one signatory. In this case the proxy would be seen to be a normal Bitcoin user that requires a second signature. The second user would be one of the anonymous recipient systems in the proxy system's group and the second signing key would be delivered to the that recipient system via a secure anonymous messaging service (note that the service may be but does not necessarily have to be the one described above).

It will be appreciated that there are many ways of implementing the proxy system 20 and recipient system functionality. For example, the proxy system may be operated by a server, collection of servers or other processing devices and may optionally by operated on a peer-to-peer basis by selected recipient systems. The recipient systems may be PCs, smartphones or other computing devices—functionality for encryption, decryption and messaging using the decentralised messaging system 10 may be via an app, client software application, API, driver, protocol layer or other approach.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

This application claims priority from GB 1804614.4 and GB 1807854.3, the content of which and the content of the abstract filed herewith is incorporated by reference.

1. A decentralised communication system comprising:
a proxy system having a single address associated with a plurality of recipient systems, the proxy system being configured to provide a received message addressed to the address to each of the plurality of associated recipient systems;
a public key data repository storing a static public key and a plurality of ephemeral public keys for each of the plurality of recipient systems;
wherein a message to a selected one of the recipient systems includes an encrypted marker and an encrypted message body,
the message body being encrypted by a sender using the recipient system's static public key, an ephemeral public key of the recipient system and private keys corresponding to the sender's static public key and a selected one of the sender's ephemeral public keys;
the marker being encrypted using the recipient's static public key and including the sender's static key, and the ephemeral public keys used to encrypt the message body,
whereby the marker is only decryptable by the selected recipient system and the encrypted marker reveals no information about the sender or recipient system.

2. The decentralised communication system of claim 1, wherein the public key data repository comprises a decentralised ledger system.

3. The decentralised communication system of claim 2, wherein the decentralised ledger system comprises a blockchain.

4. The decentralised communication system of claim 1, wherein the proxy system is one of the recipient systems and has a static public key and plurality of ephemeral public keys in the public key data repository, a message to the proxy system being sent to the single address and encrypted in the same way as a message to others of the recipient systems whereby an observer cannot distinguish proxy request messages from messages intended for other recipients on the network.

5. The decentralised communication system of claim 4, the proxy system being configured to receive a message from one of the recipient systems instructing a payment to a payee, the proxy system being responsive to create a smart contract on a decentralised ledger designating the proxy system as the payment identity and a smart contract condition that can only be met by the instructing recipient system, the proxy system being arranged to send the payee system a message referencing the smart contract.

6. The decentralised communication system of claim 1, further comprising a recipient system client, the recipient system client being executable on a recipient system to register an address for the recipient system with the proxy system for delivery of the recipient's copy of messages addressed to the single address.

7. The decentralised communication system of claim 1, further comprising a recipient system client, the recipient system client being executable on a recipient system to retrieve messages from the proxy system addressed to the single address.

8. The decentralised communication system of claim 6, wherein the recipient system client is executable on the recipient system to communicate the recipient system's static public key and ephemeral public keys to the proxy system for storing in the public key data repository.

9. The decentralised communication system of claim 6, wherein the recipient system client is executable on the recipient system to download and store locally at least a subset of the public keys from the public key data repository, the recipient system client including a user interface configured to accept user inputs for locally selecting a recipient system to message, the recipient system client being arranged to select a corresponding recipient system ephemeral public key for the message from the local store.

10. The decentralised communication system of claim 6, wherein the recipient system client is configured to attempt to decrypt the marker of each message received from the proxy system using a private key corresponding to its public static key, wherein upon successful decryption of the marker, the recipient system client being configured to recover the sender's static key, and the ephemeral public keys used to encrypt the message body for subsequently decrypting the message body.

11. A decentralised communication method comprising:
storing, in a public key data repository, a static public key, a plurality of ephemeral public keys and a link to a proxy system for each of a plurality of recipient systems;
generating, by a sending system, an encrypted message, the encrypted message having an encrypted marker and an encrypted body,
the message body being encrypted by the sender system using the recipient system's static public key, an ephemeral public key of the recipient system and private keys corresponding to the sender's static public key and a selected one of the sender's ephemeral public keys;
the marker being encrypted by the sender system using the recipient's static public key and including the sender's static key, and the ephemeral public keys used to encrypt the message body;
sending the encrypted message to an address at the proxy system that is common to the plurality of recipient systems;
providing, by the proxy system to each of the plurality of recipient systems, the received message, whereby the marker is only decryptable by the selected recipient system and the encrypted marker reveals no information about the sender or recipient system.

12. The method of claim 11, wherein the step of generating includes the step of retrieving the recipient system's static public key and one of the recipient system's ephemeral public keys from the public key data repository.

13. The method of claim 11, further comprising the step of downloading and locally caching at least a subset of the public keys from the public key data repository, the step of generating using the locally cached public keys.

14. The method of claim 11, further comprising:
storing a static public key and plurality of ephemeral public keys in the public key data repository for the proxy system and encrypting and sending a message to the proxy system in the same way as a message to others of the recipient systems whereby an observer cannot distinguish proxy request messages from messages intended for other recipients on the network.

15. The method of claim 11, further comprising:
sending, by the sending system, a message having a marker encrypted for decryption by the proxy system, the encrypted message body instructing a payment to a payee;
creating, by the proxy system a smart contract on a decentralised ledger designating the proxy system as the payment identity and a smart contract condition that can only be met by the sending system;
sending, by the proxy system a payment message having a marker encrypted for decryption by the payee, the encrypted payment message body referencing the smart contract.

16. The method of claim 11, further comprising:
transferring ownership of an account protected by a public/private key pair to recipient system by sending the private key in the encrypted body of a message having a marker encrypted for decryption by the recipient system.
